(19) United States
(12) Patent Application Publication
(10) Pub. No.: US 2010/0025331 A1
(43) Pub. Date: Feb. 4, 2010

(54) CASING FOR MONOLITHIC CHROMATOGRAPHY COLUMNS

(75) Inventors: Karin Cabrera Perez, Dreieich (DE); Klaus Kreher, Munster (DE); Willi Neuroth, Rossdorf (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GMBH, Darmstadt (DE)

(21) Appl. No.: 12/527,342

(22) PCT Filed: Jan. 19, 2008
(86) PCT No.: PCT/EP2008/000401

§ 371 Date: Aug. 14, 2009

(30) Foreign Application Priority Data
Feb. 16, 2007 (DE) 10 2007 008 360.4

(51) Int. Cl. B01D 15/22; B32B 1/06; B32B 37/06

(52) U.S. Cl. 210/656; 210/198.2; 428/76; 156/242

(57) ABSTRACT

The present invention relates to improved casings of monolithic chromatography columns, and to the production and use thereof. The chromatography columns provided with these novel casings consisting of PPS and carbon fibres have both improved long-term stabilities to a very wide variety of solvents and pressure and also permanently improved separation properties.

The present invention relates to casings of monolithic chromatography columns, and to the production and use thereof.

For the production of conventional chromatography columns containing particulate sorbents, the filling material is introduced into a stainless-steel or plastic tube with precisely fitting ends. The result of this is that the sorbent bed is in close contact with the jacket of the column and the particles are homogeneously distributed over the entire cross section of the column.

The new generation of chromatography columns now consists of silica monoliths, which can be produced via a sol-gel process for specific separation problems with a customised pore system. In order to be able to employ these monoliths for chromatography, they have to be encased with a solvent-resistant and pressure-stable material in a second step.

If, as disclosed, for example, in WO 94/19 687 A and in WO 95/03 256 A, particulate sorbents are replaced by such monolithic sorbents, the problem arises of making the casing of the sorbent both pressure-stable and liquid-tight. During their production, the monolithic sorbents may shrink, so that they may not remain in the original shape. This applies equally to both forms, both to the inorganic and to the organic mouldings. They therefore have to be provided with a new liquid-tight and pressure-stable casing after the actual production. Only in this way can it be guaranteed that sample and eluent are transported exclusively through the sorbent.

Various possibilities for liquid-tight encasing of monolithic sorbents are disclosed in DE 197 26 164. These include, for example, encasing with pressure-stable plastics, such as, for example, PEEK (polyether ether ketone) or fibre-reinforced PEEK. Attempts to encase monolithic sorbents with materials of this type have shown, however, that it is not just the mechanical stability of the casing that is crucial.

The quality of a monolithic column for HPLC can be described via the separation efficiency (N/m) on the one hand and via the peak symmetry on the other hand. A good analytical column has separation efficiencies of 70,000-100,000 N/m. In the ideal case, the peak shape corresponds to a Gaussian bell shape. Deviations from this symmetrical shape result in “fronting” or “tailing”. The inherent separation efficiency of the column body and the peak symmetry should not change any further in the chromatographic use test after encasing with a polymer for a solvent-tight seal.

In the case of unsuitable casings, the polymer does not lie against the column body leaving little dead space. From the beginning, the column exhibits pre-peaks or at least “peak fronting” as a consequence of faster passage of sample through the column body/polymer interface.

Casings with unsuitable polymers may still also provide good separation efficiency and peak symmetry in the first chromatographic test, but result in a change/impairment of the two quality parameters on further use.

One phenomenon is the increase in peak tailing on storage of the column in the mobile phase (for example storage in acetonitrile/water, 60/40, for 4 weeks) owing to the microporous structure of the casing. A further phenomenon may be the increase in peak fronting with a simultaneous decrease in the separation efficiency owing to a change in the geometry of the casing.

It was in the past thought that these unfavourable phenomena may be caused by the natural shrinkage properties of polymers on the one hand and by the swelling properties in solvents on the other hand. The encasing of rigid, brittle inorganic mouldings, for example made from silica gel, is particularly problematic. Since the polymer (for example PEEK) is melted onto the moulding at high processing temperatures, it initially adheres strongly thereto. On cooling of the polymer, “movements” (shrinkage) of the polymer occur, while the moulding remains rigid in its size. Stresses build up. If the polymer then comes into contact with solvents, it absorbs the latter and swells. The stresses that have built up in the longitudinal and transverse directions are relaxed. As a consequence, slight damage occurs to the porous silica-gel body at the interface. Due to its inherent movement, the polymer which adheres strongly to the silica gel causes the formation of holes by “dragging” silica gel at the interface. This results in a decrease in the separation efficiency, in the extreme case strong peak fronting.

An increase in peak tailing can also be explained by a micropore structure in the polymer casing, which causes uncontrolled additional diffusion processes during the chromatography process.

EP 0 990 153 A attempts to solve this problem by inserting tubes having a suitable cross section made from a fibre-reinforced PEEK (polyether ether ketone) into the monoliths. The fibre-reinforced PEEK is melted by subsequent treatment in an oven at temperatures in the range from 350 to 400° C. and is subsequently in direct contact with the surface of the encased monolith.

However, problems with peak symmetry (tailing and fronting) continue to be evident on use of the encased, monolithic chromatography columns produced in this way, meaning that the problem described above remains unsolved.

It is now thought that PEEK “flows” into the open structure of the porous monoliths during the heat treatment for melting the casing, as described in EP 0 990 153 A. Since the PEEK has a different chemical structure and different physical properties to the modified silica-gel monolith, while the latter makes up the main mass of the finished product, it is assumed that this is, inter alia, a cause of the undesired behaviour. During use, the “flow” into the open structure in the edge regions gives rise to non-specific interaction centres, which emanate from PEEK and come into contact with the analyte. Depending on the chemical structure of the analyte, this results in some cases in peak tailing or fronting.

Furthermore, very strong adhesion arises between the monolith and the PEEK during the encasing, meaning that the two materials cannot be separated after the encasing process. It also appears that stresses build up in the edge region during cooling after the melting of the PEEK, which can result in cracks and dead spaces at the interface and can cause fronting.

In addition, the PEEK casing is melted onto the monoliths at an oven temperature of about 400° C. This temperature is significantly, about 55° C., above the melting point of PEEK (about 340° C.). These temperature conditions have an adverse effect on monoliths which contain C-18 chains after RP surface derivatisation (RP=reversed phase). This surface derivatisation is stable up to a temperature of about 200° C. At higher temperatures, the C-18 chains are increasingly burnt off, and silanol groups increasingly form on the surface of the silica-gel monoliths. In particular in the case of separation of basic compounds, silanol groups cause tailing.

The object of the present invention is therefore to provide casings leaving little dead space which result in neither peak fronting nor tailing on use after completion of the encased monolithic chromatography columns. A further object of the present invention is to provide both a suitable polymer material and a process for encasing monoliths which does not have an adverse affect on the properties of the monolithic chromatography columns.

The object is achieved in accordance with the invention by a monolithic moulding which is encased with a thermoplastic leaving little dead space, where the casing comprises polyphenylene sulfide.

In particular, the object according to the invention is achieved by monolithic mouldings which are encased with a fibre-reinforced thermoplastic leaving little dead space. In particular, fibre-reinforced polyphenylene sulfide has proven particularly suitable for the production of the casing.

It has been found that the monolithic mouldings encased in accordance with the invention have particularly good properties if a plastic which has a viscosity in the molten state of between 80 and 180 ml/10 min by the MVR method is used for the production of the casing. This applies both to fibre-reinforced and non-fibre-reinforced casings. It has been found by means of experiments that this requirement is met, in particular, by polyphenylene sulfide.

Carbon fibres have proven particularly suitable for the fibre reinforcement of the plastic casing. Thus, the present application relates to encased monolithic mouldings which are encased with a carbon fibre-reinforced plastic.

Corresponding monolithic mouldings encased with fibre-reinforced plastics have particularly good properties as chromatography columns.

The process according to the invention for the production of an encased monolithic moulding as described comprises the following steps:
a) carbon fibres in an amount of 1 to 50% by weight are added to polyphenylene sulfide granules, and the mixture is shaped by means of injection-moulding equipment to give a pipe, tube or half-shells having a slightly larger internal diameter,
b) the moulding to be encased is introduced into the pipe, tube or into two half-shells,
c) the pipe, the half-shells or the tube is (are) positively bonded to the surface of the moulding by melting and pressing or drawing.

The present invention likewise relates to the use of a corresponding monolithic moulding encased with fibre-reinforced plastic for the chromatographic separation of at least two substances.

Experiments with a wide variety of polymer materials and use tests have shown that, in particular with polymers of this type, it is possible to produce products having improved properties which have low viscosities on melting.

Ideally, a casing for monolithic sorbents satisfies the following requirements and is:
solvent-stable to the customary solvents in chromatography, such as, for example, acetonitrile, MeOH, water, dioxane, heptane, etc., since the mobile phase consists of one or more of these components;
mechanically stable in order to be able to chromatograph faster without problems at higher flow rates. At higher flow rates, a back-pressure builds up within the column. The polymer should not change its geometry even at a back-pressure of up to 200 bar;
in close contact with the monolithic column body leaving little dead space in order to avoid reductions in separation efficiency and fronting of the substance peaks or pre-peaks due to uncontrolled eluent flows at the polymer/column body interface;
pore-free in order to prevent disadvantageous tailing of the substance peaks due to uncontrolled diffusion processes in micropores of the casing.

It has been found that, in particular, the viscosity of the polymers used for the casing is of major importance for achieving close contact with monolithic mouldings leaving little dead space. A suitable mechanical stability of the casing can be achieved by fibre reinforcement with suitable fibres which are compatible with the polymer. Experiments in this connection have shown that suitable polymers having low viscosity can be converted into casings having the requisite chemical and mechanical stability if they are reinforced with fibres which are compatible with the polymer and can be applied to the monoliths together with the polymer with as little dead space as possible.

Although it is possible to use a wide variety of polymers which have low viscosity in the molten state to produce fibre-reinforced casings for monolithic chromatography columns which have good properties at the beginning, it has, however, been found that only very few meet the high requirements for the present objective.

Experiments have shown that, in particular, the use of polyphenylene sulfide enables the production of casings which can be applied to the surface of the monolith in a suitable process with virtually no dead space, so that the original properties of the encased chromatography column are retained virtually unchanged.

The problem of fronting and tailing can also be substantially minimised through the use of corresponding plastic tubes made from fibre-reinforced PPS (=polyphenylene sulfide) as casings.

Particularly suitable in accordance with the invention are plastic tubes produced from a high-temperature-resistant thermoplastic PPS. This plastic is a polymer having the general formula (SC₆H₄)ₙ. In general, PPS is produced industrially by polycondensation of 1,4-dichlorobenzene with sodium sulfide and has partially crystalline properties, which is why it has to be melted during processing. As a consequence of its structure, this PPS has more suitable properties for the production of plastic casings for monolithic chromatography columns than, for example, the PEEK (polyether ether ketone) used in EP 0 990 153 A. In particular, the PPS used is distinguished, for example compared with PEEK, by the following properties:
shorter repeat units, ⅓ shorter
higher crystalline content, about 80%
the injection-moulded tubes are therefore glossy
PPS exhibits a “flushing” effect, i.e. it flows very strongly
PPS has a relatively low molecular weight
PPS has a somewhat lower viscosity.

However, it has been found that even a casing consisting of the pure plastic already meets the requirements with respect to separation efficiency and peak symmetry. However, further experiments have shown that the requirements regarding mechanical stability can be improved further if fibre-reinforced plastic tubes are used.

The plastic casings are therefore produced using fibre-reinforced PPS, which is shaped in advance into tubes having a suitable cross section. Although the addition of a wide variety of fibres produces improved properties, carbon fibre-reinforced PPS is preferably employed since fibres of this type have high compatibility with this plastic and can be converted in the desired use into a liquid-resistant and pressure-stable casing leaving little dead space which withstands the high chemical and in particular high mechanical requirements.

In this connection, a casing leaving little dead space means in accordance with the invention that the dead space between the monolithic moulding and the casing is so small that it does not have an adverse effect on the separation efficiency of the chromatography column.

Organic and inorganic mouldings and also inorganic/organic hybrid mouldings, as employed, for example, as sorbents for chromatographic purposes, can be encased with the casing according to the invention. For chromatographic separations, the mouldings can be modified with separation effectors, but this generally does not affect their other properties. The casing according to the invention is suitable for rigid, inflexible mouldings. Brittle, inorganic mouldings, as disclosed in WO 94/19 687, WO 95/03 256 or WO 98/29 350, can also be encased leaving little dead space in accordance with the invention.

These disadvantages can be overcome per se, as also described in EP 0 990 153 A, by the addition of stabilisers, such as fibre materials, inorganic materials or pigments, for example chalk, talc, mica or inorganic oxides, such as silicon dioxide. These additives also result in mechanical stabilisation of the casing.

The disadvantages can be avoided, in particular, in accordance with the invention through the use of fibre-reinforced PPS which comprises, as stabilisers, fibre materials, such as, for example, glass or in particular carbon fibres. Besides a reduction in the natural swelling or shrinking properties of the polymer, the fibres present exhibit a particularly effective increase in the mechanical stability. Carbon fibre-reinforced PPS has proven very particularly suitable for the purpose according to the invention, although the amount of carbon fibres present in the polymer is also of major importance for the achievable stability.

The more fibres are added as stabilisers to the plastic, the more brittle it becomes. It has been found that the plastic used in accordance with the invention only remains sufficiently flexible to be converted into casings of monolithic chromatography columns up to a proportion of 50% by weight of fibres. The addition of only 1% by weight of carbon fibres can be observed to have a clear advantageous effect on the properties of the PPS casing. However, it has been found that the fewer fibres are added, the more the swelling or shrinking properties of the polymers come to the fore. Since these very properties are to be avoided through the addition of fibres, it is advantageous for the fibre content in the polymer to be at least 15% by weight. PPS casings having a fibre content of 15-35% by weight are therefore preferably produced.

Particular preference is given to the production of PPS casings having a fibre content of 20-35% by weight; very particular preference is given to the use of corresponding polymers having a fibre content of 27-33%.

In the encasing of mouldings with corresponding fibre-reinforced plastics, no or only a slight decrease in the separation efficiency has been observed, even on extended storage in solvents or on frequent use.

For effective production of a moulding encased with fibre-reinforced PPS, the plastic composition used must have a certain viscosity in the molten state.

The viscosity is determined by methods known per se.

In the plastics-processing industry, the viscosity of thermoplastics is usually determined by the melt volume rate (MVR) in accordance with DIN ISO 1133. A standardised apparatus is used. The central constituents thereof are a heatable, vertical cylinder (internal diameter 9.55 mm) with discharge nozzle (internal diameter 2.06 mm, length 8.00 mm) and a matching piston with position markings (30.00 mm which can be read by the apparatus), which can be loaded with a weight. The apparatus comprises precise measurement systems for determining the piston path length that has been travelled and for time and temperature measurement.

In order to determine the viscosity of plastics for a column casing according to the invention, a process in accordance with DIN ISO 1133 was used:

In order to carry out the determination, the apparatus is pre-heated to a fixed temperature of 320° C. The pre-dried (150° C., 8 h) plastic or plastic compound (10 g of powder or granules) is introduced into the cylinder and compressed. When the measurement temperature (320° C.) has been reached, it is held for a further 240 s. The weight (10 kg) is subsequently placed on top automatically, and the melt is allowed to flow out. The measurements begin when the lower position marking on the piston is recognised and end when the upper marking is recognised. The melt volume rate (MVR) is then determined by the instrument software from the piston path length travelled, the measurement time intervals (2 s) and the known piston surface area and output in the usual unit of ml/10 min.

The pre-drying time and temperature (150° C., 8 h), the sample weight (6 g), the measurement temperature (320° C.), the weight (10 kg) and the measurement time intervals (2 s) are standards aimed specifically at the determination of the MVR of PPS and PPS compounds. The instrument geometry and the waiting time (240 s) are defined in DIN ISO 1133.

Plastics have different viscosities, inter alia depending on their degree of crosslinking and their chain length. The addition of stabilisers, such as, for example, fibres, modifies the viscosity of the substances again. They become significantly more viscous thereby, meaning that these aspects must be taken into account when selecting a PPS composite composition which is suitable in accordance with the invention.

Plastics are generally available as granules or powders. For the casing according to the invention, both forms can be employed. However, it must be noted that the viscosity of powders may change during subsequent processing steps, while this usually does not occur in the case of granules. One reason for this is that the powder frequently comes directly from the polymerisation batch and may also comprise a residual content of monomers and oligomers. During compounding, the monomers escape as gases, and post-polymerisation may occur. This slightly increases the viscosity of the plastics.

It has been found that the plastic according to the invention is particularly suitable for encasing leaving little dead space on addition of about 30% by weight of fibres, in which case it has an initial viscosity of greater than 120 ml /10 min by the MVR method. Fibre-containing plastic compositions having values below 80 ml/10 min by the MVR method are so viscous after compounding that, although they can still be extruded to give tubes, they can, however, only be applied to the mouldings with great difficulty. The upper limit of the measured MVR values of the plastic compositions which can be employed in accordance with the invention is determined essentially by the amount of added PPS. However, the composition should not become too liquid during melting onto the moulding.

Preference is therefore given to the use of pulverulent PPS having an MVR of 80 to 210, particularly preferably between 100 and 180. In the case of granules, preference is given to the use of materials having an MVR of 80 to 210, particularly preferably 100 to 180.

For the novel encasing of mouldings, the plastics are firstly compounded, i.e. additives, such as, for example, fibres, colorants, etc., are added. This is preferably carried out by controlled addition of the additives with simultaneous processing via an extruder screw. More precise process parameters are known to the person skilled in the art and are given in handbooks, such as, for example, in Hensen, Knappe and Potente, “Handbuch der Kunststoffextrusionstechnik” [Handbook of Plastics Extrusion Technology], Karl Hanse Verlag, (1986/1989).

During compounding, the later viscosity of the plastic is affected by the type of additives and in some cases also by the time of addition. If fibres are added at an early stage, they are comminuted during compounding. For example, fibres having an initial length of 6 mm may only still have an average length of a few μm after compounding. For the encasing according to the invention, the length of the added fibres is of minor importance since the fibres are also comminuted by the subsequent processing steps. Fibres are therefore usually added at an early stage.

After compounding with about 30% of fibres, the viscosity of the fibre-reinforced plastic composition which is suitable in accordance with the invention is typically between 80 and 180 ml/10 min by the MVR method, preferably between 100 and 150 ml/10 min by the MVR method, where the upper limit is determined principally by availability, as above in the case of non-fibre-reinforced starting materials.

After compounding, tubes are produced from the material mixture by known processes, such as extrusion or injection moulding. Shaping processes of this type are known and are revealed, for example, by textbooks, such as Knappe, Lampl and Heuel, “Kunststoffverarbeitung und Werkzeugbau” [Plastics Processing and Mould Construction], Karl Hanse Verlag (1992). The tubes are preferably produced by an injection-moulding process.

The monolithic moulding is subsequently introduced into the plastic tube. The tube is then brought into closest possible contact with the moulding by warming. This step is crucial for encasing leaving little dead space. Only materials having the viscosity which is suitable in accordance with the invention can be joined sufficiently tightly to the moulding. The use of homogeneous tubes which have a uniform wall thickness over their entire length is advantageous in this step.

In order to carry out this production step, suitable processes are known to the person skilled in the art, for example from the production of insulated cables. One way of producing monolithic sorbents encased in this way consists, for example, in extruding the plastic onto the moulding, where the monolithic moulding is fed through a crosshead die in parallel to the extrusion of a tube. The freshly extruded, still-hot tube surrounds the moulding and is additionally pressed against the moulding, for example by a pressure device. It is also possible to warm a pre-shaped tube instead of producing a tube by extrusion. This mechanical pressure and the additional sintering during cooling cause the formation of a tight casing. It is also possible to introduce the moulding into a prefabricated tube whose internal diameter is slightly larger than the external diameter of the moulding and then to warm the plastic so that the tube can be taken off at the end diameter and surrounds the moulding closely. The casing is preferably produced as just described or by a further variant, in which the plastic casing is produced by an injection-moulding process and by single or multiple shrinking-on.

In order to carry out the injection-moulding process, 30% by weight of carbon fibres, for example, are added to the PPS granules, and the mixture is fed to the injection-moulding equipment. The resultant materials are mechanically stable and resistant to most solvents.

The PPS employed advantageously has a melting point of about 285° C., which is thus about 55° C. below the melting point of PEEK. This low melting point enables surface derivatisations of the monoliths, for example with C18 chains, to be impaired less.

It is also possible to encase monoliths with prefabricated fibre-reinforced PPS half-shells. The casing is applied here by partial melting and suitable pressing onto the surface of the monoliths.

Monoliths which have been encased with PPS tubes or half-shells advantageously no longer exhibit the typical fronting and “knicktailing”. These advantageous properties are also retained in the longer term, so that it can be assumed that this plastic is not as available as chromatographic surface as the fibre-reinforced PEEK used for this purpose in EP 0 990 153 A. In contrast to PEEK, PPS has a high crystalline content (80% vs. 40-50% for PEEK).

Owing to the chemical structure of PPS, this plastic is apparently not as available as chromatographic surface as the PEEK described above, meaning that specific interactions between the mixture to be separated and the plastic casing are not as crucial.

It also appears that, compared with PEEK casings, fewer stresses arise on cooling of the PPS casing, consequently causing fewer cracks and dead spaces in the edge region. This results in significantly minimised fronting.

The fibre-reinforced polymers according to the invention are particularly suitable for the production of polymer casings for porous monoliths with mono-, bi- or multimodal pore systems comprising macropores and mesopores, and having diameters of 1 mm to 1 m, preferably 1.5 mm to 50 mm, consisting of SiO₂, hybrid SiO₂, Al₂O₃, TiO₂ and other metal oxides. Monolithic chromatography columns encased with fibre-reinforced PPS and having particularly good properties are obtained, in particular, if they are monolithic columns comprising SiO₂ or hybrid SiO₂. In accordance with the invention, however, corresponding disc-shaped preparative monolith discs can also be encased with the corresponding plastic in a manner according to the invention. The plastic used is preferably a suitable fibre-reinforced plastic.

For use as chromatography column, the monoliths encased in accordance with the invention can then be provided with corresponding connectors, filters, seals, etc. The casing can terminate flush with the sorbent or project at the ends. Designs of this type are known for chromatography columns containing particulate or monolithic sorbents.

The monolithic sorbents encased in accordance with the invention exhibit excellent separation properties. Even after storage in solvents and frequent use, only a slight impairment in the separation efficiencies, or none at all, is evident. The casing according to the invention thus ensures for the first time the production of chromatography columns which are both mechanically and chemically stable and are in contact with the monolithic mouldings leaving little dead space.

The present description enables the person skilled in the art to use the invention comprehensively. Even without further comments, it is therefore assumed that a person skilled in the art will be able to utilise the above description in the broadest scope.

If anything is unclear, it goes without saying that the publications and patent literature cited should be consulted. Correspondingly, these documents are regarded as part of the disclosure content of the present description.

For better understanding and in order to illustrate the invention, examples which are within the scope of protection of the present invention are given below. These examples also serve to illustrate possible variants. Owing to the general validity of the inventive principle described, however, the examples are not suitable for reducing the scope of protection of the present application to these alone.

It furthermore goes without saying to the person skilled in the art that, both in the examples given and also in the remainder of the description, the component amounts present in the compositions always only add up to 100% by weight, based on the composition as a whole, and cannot exceed this, even if higher values could arise from the percentage ranges stated. Unless otherwise indicated, % data are % by weight, with the exception of ratios which are reproduced in volume data, such as, for example, eluents, for the preparation of which solvents are used in a mixture in certain volume ratios.

The temperatures given in the examples and the description as well as in the claims are always in ° C.

### EXAMPLES

### Example 1

2 silica monoliths having a diameter of 4.6 mm and a length of 12.5 cm, produced in accordance with WO 94/19687 and WO 95/03256 (Nakanishi Patents), are pre-dried at 200° C. for at least 3 h in a drying cabinet. The pre-dried Si monoliths are subsequently placed in fibre-reinforced PPS tubes (length 11.5 cm, internal diameter 5.0 mm and external diameter 9 mm) and covered with a Teflon shrink tube. (The PPS tubes are produced by injection moulding from granules to which 30% of carbon fibres are added). The columns provided in this way are mounted in a frame, placed in an oven and left at 380-400° C. for 3-6 minutes. The mounted columns are subsequently removed from the oven. On cooling to room temperature, the Teflon shrink tube presses the molten PPS against the monolith leaving little dead space. The columns encased in this way are shortened at both ends, to a final length of 10 cm. Threads are cut at both column ends and matching end fittings are screwed on.

Investigations on products produced in this way gave the following results:

The columns were investigated chromatographically in the adsorption system with heptane/dioxane (95/5; v/v) and 2-nitroanisole. The following separation efficiencies and peak symmetries were obtained:

| | Separation efficiency N/m | Peak symmetry Tusp |
|---|---|---|
| Column 1 | 139730 | 0.97 |
| Column 2 | 138540 | 0.85 |

### Example 2

2 silica monoliths having a diameter of 4.6 mm and a length of 10 cm are encased with fibre-reinforced PPS by the process described under Example 1. They are subsequently soaked on-column with a 20% solution of N,N-diethyl-aminodimethyloctadecylsilane in toluene and derivatised in through-flow in a column oven for 2 hours at 50° C. The column is then washed on-column with toluene, and the on-column derivatisation (now end-capping) is repeated with 100% hexamethyldisilazane. The resultant monolithic column is re-washed with toluene and 2-propanol, giving an RP-18e surface modification known to the person skilled in the art.

The modified columns were investigated chromatographically in reversed phase mode with acetonitrile/water (60/40; v/v) and anthracene.

The following separation efficiencies and peak symmetries were obtained with the products obtained in this way:

| | Separation efficiency N/m | Peak symmetry Tusp |
|---|---|---|
| Column 1 | 122660 | 1.03 |
| Column 2 | 120530 | 0.94 |

### Example 3

Basic pharmaceutical active compounds are chromatographed on a monolithic chromatography column produced as described under Examples 1 and 2 and compared with conventional monolithic chromatography columns encased with PEEK. The columns encased in accordance with the invention with fibre-reinforced PPS exhibit significantly better symmetry properties:

| | |
|---|---|
| Amitryptyline | Procainamide |

| | N/m | Tusp | N/m | Tusp |
|---|---|---|---|---|
| Monolithic | n.d. | n.d.. | 18380 | 3.08 |
| RP 18e column, | | | | |
| PEEK encased | | | | |
| (conventional) | | | | |
| Monolithic | 48810 | 3.58 | 46220 | 1.76 |
| RP 18e column, | | | | |
| PPS encased | | | | |
| (invention) | | | | |

n.d. = not determined as cannot be evaluated

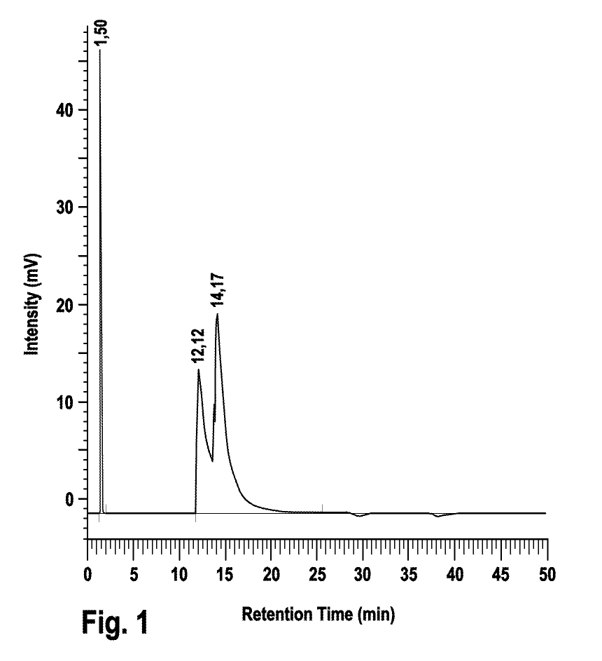

FIG. 1 shows a separation of triptyline using a monolithic RP 18e column, PEEK encased (conventional).

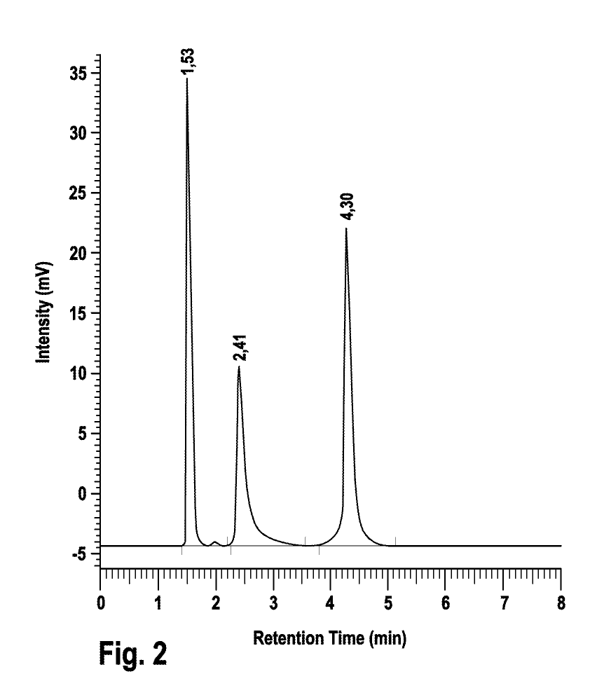

FIG. 2 shows a separation of procainamide using a monolithic RP 18e column, PEEK encased (conventional).

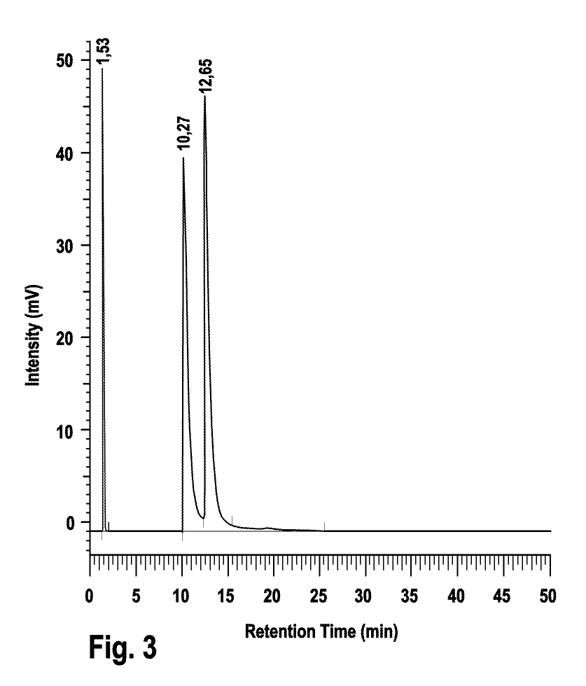

FIG. 3 shows a separation of triptyline using a monolithic RP 18e column, PPS encased (according to the invention).

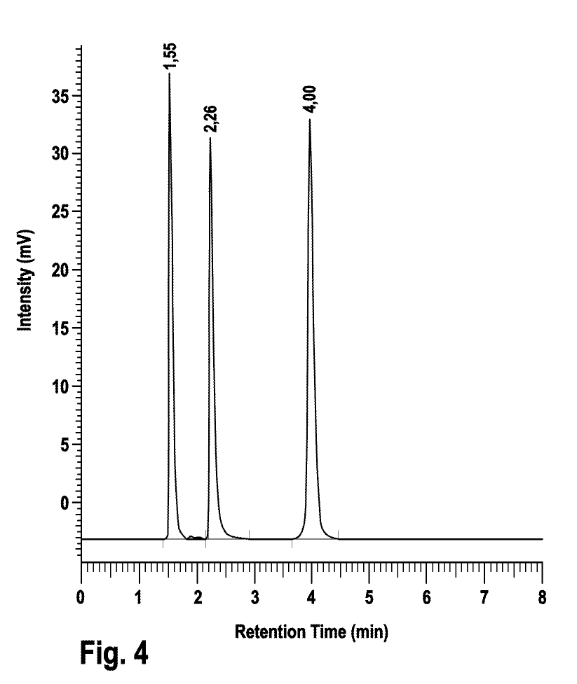

FIG. 4 shows a separation of procainamide using a monolithic RP 18e column, PPS encased (according to the invention).

In summary, it should be noted regarding the examples that substances having less tailing and fronting and thus improved peak symmetries can be chromatographed using monolithic chromatography columns encased with fibre-reinforced PPS tubes.

1. Monolithic moulding which is encased with a thermoplastic, characterised in that the casing comprises polyphenylene sulfide.

2. Monolithic moulding which is encased with a fibre-reinforced thermoplastic, characterised in that the casing comprises fibre-reinforced polyphenylene sulfide.

3. Monolithic moulding according to one of claims 1 and 2, produced using a fibre-reinforced plastic which has a viscosity in the molten state of between 80 and 180 ml/10 min by the MVR method.

4. Encased monolithic moulding according to one or more of claims 1 to 3, characterised in that the fibre reinforcement is produced by carbon fibres.

5. Chromatography column containing an encased monolithic moulding according to one or more of claims 1 to 4.

6. Process for the production of an encased monolithic moulding according to one or more of claims 1 to 4, characterised in that
a) carbon fibres in an amount of 1 to 50% by weight are added to polyphenylene sulfide granules, and the mixture is shaped by means of injection-moulding equipment to give a pipe, tube or half-shells having a slightly larger internal diameter,
b) the moulding to be encased is introduced into the pipe, tube or into two half-shells,
c) the pipe, the half-shells or the tube is (are) positively bonded to the surface of the moulding by melting and pressing or drawing.

7. Use of an encased monolithic moulding according to one or more of claims 1 to 4 for the chromatographic separation of at least two substances.
